(19) United States
(12) Patent Application Publication
(10) Pub. No.: US 2005/0217186 A1
(43) Pub. Date: Oct. 6, 2005

(54) Strap attachment device

(76) Inventor: Randy Thomas Bartmas, Ramona, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/818,746

(22) Filed: Apr. 5, 2004

(51) Int. Cl. F16L 3/24; E04B 7/02

(52) U.S. Cl. 52/90.1

(57) ABSTRACT

A Strap Attachment Device of the present invention includes a base bracket which attaches to the Hilte fastening system having an extension handle. The base bracket includes a slide portion which receives a sliding U-clip. This U-Clip is sized to receive the width of a typical duct strap and may include a magnetic portion in order to securely receive the duct strap within the U-Clip. Once a duct strap is in position within the U-Clip, the Hilte fastening system is positioned against the ceiling such that the duct strap is properly placed, and the Hilte gun is fired thereby fastening the duct strap to the ceiling. Once the duct strap is fastened to the ceiling, the Hilte fastening system with the Strap Attachment Device is moved away such that the magnetic portions of the U-Clip detach from the duct strap, leaving the duct strap hanging where attached to the ceiling.

### BACKGROUND OF THE INVENTION

Over the years, a number of fastening systems have been invented in order to attach construction materials together during the construction process. One such fastening system includes a fastening tool with a charge-powered attachment gun, commonly called a Hilte Gun, which uses a gunpowder charge to forcibly deploy a fastener. A typical use for the Hilte fastening system is to attach pieces of ducting strap to the ceiling for securing heating and air conditioning ducting in place.

While the Hilte fastening system is very useful for attaching items to a ceiling, it unfortunately requires the person using the system to be in close proximity to the attachment location in the ceiling. Typically, this requires the user to repeatedly climb a ladder, attach the duct strap, climb down the ladder, move the ladder to the next location, and repeat the process. Since a ducting system may require hundreds of straps in an installation, the process of climbing and moving a ladder alone can involve a significant amount of time.

In order to minimize the requirement that a user of the Hilte fastening system climb a ladder in order to be close enough to the ceiling, an extension handle was developed. The extension handle provides for the attachment of a Hilte fastening gun to the distal end of the handle, and provides a trigger extension such that the Hilte fastening gun may be activated from the proximal end of the extension, such as a person standing on the ground.

Although the extension handle provided for the remote activation of the Hilte fastening system, the extension handle was only useful when attaching fasteners only to the ceiling. It was difficult, if not impossible, to properly position a ducting strap on the ceiling for fastening using the Hilte fastening system because the user was standing on the floor and not on the ladder as previously done.

An example of the prior art Hilte fastening system is shown in FIG. 1 and generally designated 10. Hilte fastening system 10 includes a Hilte gun 12 and an extension handle 14. Hilte gun 12 includes a body 16 having a handle 18 with a back 20. A trigger mechanism 22 provides for the discharge of a fastener 40 from chamber 24 and barrel 26. Extension handle 14 includes a base 28 sized to receive back 20 of body 16. Gun 12 is secured in place on extension handle 14 by clamp 30 with cinch screw 32. Extension handle 14 includes a pole 14 of varying lengths, such as eight (8) feet, and is equipped with a trigger extension 36 with a trigger engaging portion 38.

In use, a fastener 40 is inserted into the barrel 26 of the Hilte gun 12, and barrel 26 is positioned against a surface, such as a ceiling (not shown this Figure), to compress barrel 26 in direction 44 into chamber 24. Once barrel 26 is compressed, the trigger 22 is pulled by remotely moving trigger engaging portion 38 in direction 50 thereby discharging the gunpowder charge and forcing fastener 40 in direction 46 for insertion into the ceiling. Once spent, the gunpowder casing (not shown) is discharged through aperture 48, and the process is repeated.

### SUMMARY OF THE INVENTION

In light of the shortcomings outlined above, the present invention was developed in order to maintain a ducting attachment strap in a proper position for attachment to the ceiling using the Hilte fastening system. The Strap Attachment Device of the present invention includes a base bracket which attaches to the Hilte fastening system having an extension handle. The base bracket includes a slide portion which receives a sliding U-clip. This U-Clip is sized to receive the width of a typical duct strap and may include a magnetic portion in order to securely hold the duct strap in position within the U-Clip.

Once a duct strap is in position within the U-Clip, the Hilte fastening system is positioned against the ceiling such that the duct strap in its proper location, and the Hilte gun is fired thereby fastening the duct strap to the ceiling. Once the duct strap is fastened to the ceiling, the Hilte fastening system with the Strap Attachment Device is moved away such that the magnetic portions of the U-Clip disengage the duct strap, leaving the duct strap hanging from the ceiling.

### BRIEF DESCRIPTION OF THE DRAWINGS

The novel features of this invention, as well as the invention itself, both as to its structure and its operation, will be best understood from the accompanying drawings, taken in conjunction with the accompanying description, in which reference characters refer to similar parts, and in which:

FIG. 2 is a side view of the Strap Attachment Device of the present invention showing attachment to the Hilte Fastening System equipped with an extension handle and showing the sliding U-Clip which receives and holds a duct strap in the proper position for attachment to the ceiling;

FIG. 3 is a detailed view of the Strap Attachment Device of the present invention showing the strap engaging U-Clip and its movement along the base bracket, and showing the insertion of a duct strap into the U-Clip;

FIG. 4A shows the positioning of the duct strap holders and the insertion of a duct strap into the U-Clip;

FIG. 4B shows the Hilte fastening system equipped with a Strap Attachment Device of the present invention, as positioned against the ceiling in a typical installation of a duct strap and with the duct strap in place in the U-Clip; and

FIG. 4C shows the resultant duct strap hanging following the use of the Hilte fastening system equipped with the Strap Attachment Device of the present invention.

### DESCRIPTION OF THE PREFERRED EMBODIMENT

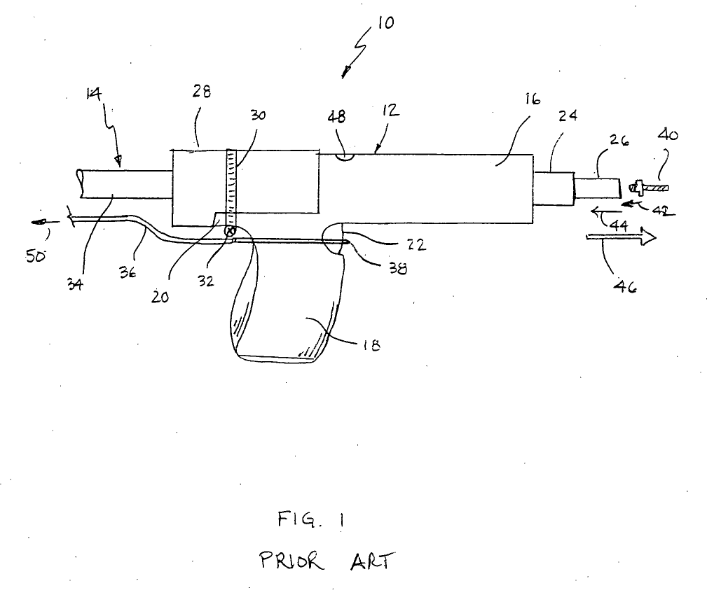

Referring now to FIG. 2, the Strap Attachment Device of the present invention is shown and generally designated 100. Strap Attachment Device 100 includes a base bracket 102 formed with a slide portion 104. A slide 106 is positioned over slide portion 104 and moveable in directions 105. Slide 106 is equipped with a U-Clip 108 sized to receive a duct strap (not shown in this Figure) and is formed with a right-angled portion 110. U-Clip 108 may be extended as shown by dashed lines 109 to provide for added support for duct straps 60. Base bracket 102 may also be formed with a spent charge ejection aperture 112 for removal of gun-powder charges (not shown) after use.

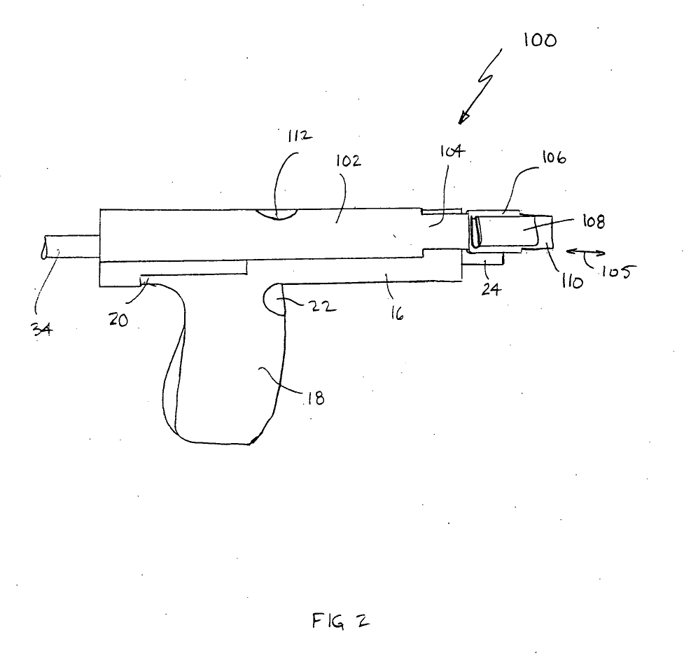

Referring now to FIG. 3, the Strap Attachment Device 100 is shown in perspective and details the cooperation of slide 106 over slide portion 104. As shown, slide 106 is positioned and retained over slide portion 104 by bends 113. Once retained, slide 106 may move in direction 128 along slide portion 104. In a first position, slide 106 is extended away from base 102 in direction 129. Spring 126 may be inserted between right angle portion 122 of the distal end 120 of slide portion 104, and the right angle portion 124 of the distal end 110 of slide 106. The presence of spring 126 urges slide 106 in direction 129 to retain slide 106 in the first position.

Slide 106 includes a U-Clip 108 which is formed with a channel 116 for receiving duct strap 60. The width 117 of U-Clip 108 is approximately equal to width 64 of duct strap 60 such that when duct strap 60 is inserted into channel 116, the duct strap is securely engaged. Additionally, magnetic panels 114 and/or 118 may be included on slide 106 to maintain duct strap 60 securely in place. More particularly, magnetic panel 114 may be attached to, or integral to, slide 106 to secure the duct strap in place. Further, magnetic panel 118 may be positioned in U-Clip 108 to hold the duct strap firmly within the U-Clip 108, thereby providing a secure mounting for the duct strap 60 to ensure that the right angle portion 62 of duct strap 60 is held directly adjacent barrel 26. This secure mounting enables the Hilte fastening system equipped with the Strap Attachment Device 100 to be moved into position for hanging a duct strap 60.

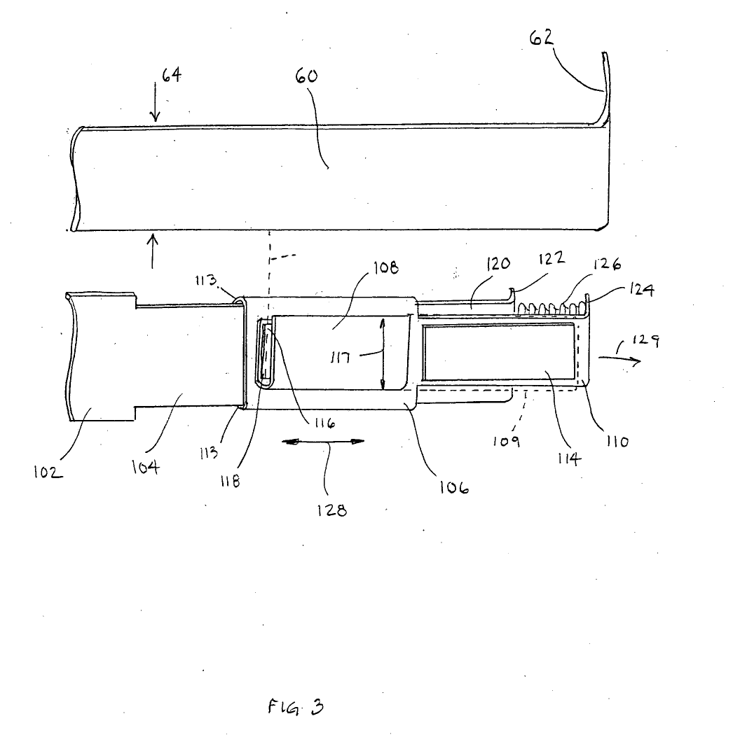

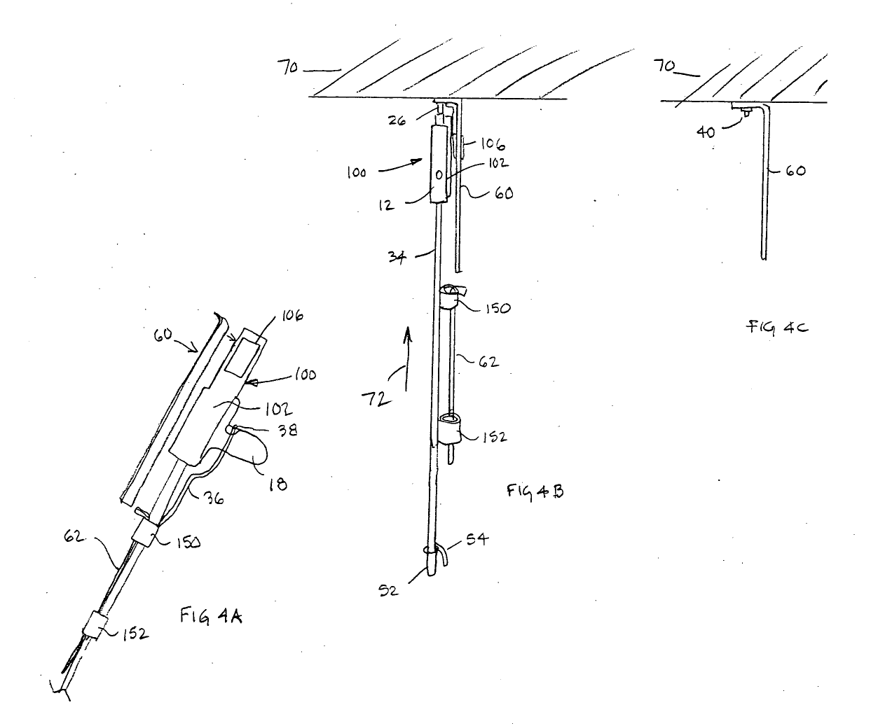

Referring now to FIGS. 4A, 4B and 4C, the typical use of a Hilte fastening System equipped with the Strap Attachment Device 100 is shown as used to hang a typical duct strap. Referring first to FIG. 4A, the Hilte fastening system equipped with the Strap Attachment Device 100 is loaded with a duct strap 60 by placing the duct strap 60 in U-Clip 108 as described above. A supply of duct straps 60 may be conveniently held in a holder consisting of a first and second support 150 and 152. These supports attach directly onto the extension handle 34 and provide for a self contained fastening system for duct straps.

Referring now to FIG. 4B, once a duct strap 60 is in position within the U-Clip 108, the Hilte fastening system with the Strap Attachment Device 100 is positioned against the ceiling 70 such that the duct strap 60 is properly placed. Once in position, the entire Hilte fastening system and Strap Attachment Device 100 are urged upwards in direction 72 to compress spring 126. Once compressed, the Hilte gun is fired thereby forcibly ejecting the fastener 40 and fastening the duct strap 60 to the ceiling. Firing is accomplished by activation of the remote trigger 54 on handle 52 which in turn pulls trigger engaging portion 38 in direction 50 and pulls trigger 22.

Referring now to FIG. 4C, once the duct strap 60 is fastened to the ceiling 70, the Hilte fastening system with the Strap Attachment Device 100 is moved away such that the magnetic portions 114 and 118 of the U-Clip 108 detach from the duct strap 62, leaving the duct strap 62 hanging where attached to the ceiling 70 by fastener 40.

While the Strap Attachment Device of the present invention as herein shown and disclosed in detail is fully capable of obtaining the objects and providing the advantages herein before stated, it is to be understood that it is merely illustrative of preferred embodiments of the invention and that no limitations are intended to the details of construction or design herein shown other than as described in the appended claims.

1. A strap attachment device, comprising:
a base bracket formed with a slide portion;
a slide positioned over said slide portion and formed with a U-clip sized to receive a duct strap, and formed with a right-angled portion;
wherein a duct strap is positionable within said U-clip and bendable over said right-angled portion.

2. The strap attachment device of claim 1, wherein said duct strap defines an axis, and said slide is slidable with respect to said slide portion along said axis of said duct strap.

3. The strap attachment device of claim 1, further comprising:
a spring positioned between said right angled portion of said U-clip and said base bracket to urge said U-clip from a first position wherein said U-clip is near said base bracket to a second position wherein said right-angled portion of said U-clip is away from said base bracket.

4. The strap attachment device of claim 1, further comprising a magnetic element on said slide to releasably retain said duct strap against said slide.

5. A strap attachment device for a fastening system having a barrel defining an axis and sized to receive a fastener, said strap attachment device comprising:
a base bracket attached to said fastening system and parallel to said axis, and formed with a slide portion;
a slide positioned over said slide portion and slidable parallel within said base bracket and parallel to said axis;
a U-clip extending from said slide and sized to receive a duct strap, and formed with a right-angled portion;
wherein a duct strap is positionable within said U-clip and bendable over said right-angled portion; and
a means for attaching said duct strap to a surface.

6. The strap attachment device of claim 5, wherein said means for attaching said duct strap to a surface comprises a rotating barrel for receiving a threaded fastener.

7. The strap attachment device of claim 5, wherein said means for attaching said duct strap to a surface comprises a charge-based fastener for forcibly ejecting said fastener from said barrel.

8. The strap attachment device of claim 5, further comprising a magnetic panel attached to said slide to magnetically attract a duct strap to said slide.

9. The strap attachment device of claim 5, further comprising a magnetic panel within said U-clip to releasibly retain said duct strap with said U-clip.

10. A strap attachment device comprising:
a fastening system having a barrel defining an axis and sized to receive a fastener;
a base bracket attached to said fastening system and parallel to said axis, and formed with a slide portion;
a slide positioned over said slide portion and slidable on said slide portion of said base bracket and parallel to said axis;
a U-Clip extending from said slide and sized to receive a duct strap, and formed with a right-angled portion;
wherein a duct strap is positionable within said slide and bendable over said right-angled portion wherein at least a portion of said duct strap passes through said axis; and
a means for attaching said duct strap to a surface.

11. The strap attachment device of claim 10, further comprising a magnetic panel attached to said slide to magnetically attract a duct strap to said slide.

12. The strap attachment device of claim 10, further comprising a magnetic panel within said U-clip to releasibly retain said duct strap within said U-clip.

13. The strap attachment device of claim 10, wherein said means for attaching said duct strap to a surface comprises a rotating barrel for receiving a threaded fastener.

14. The strap attachment device of claim 10, wherein said means for attaching said duct strap to a surface comprises a charge-based fastener for forcibly ejecting said fastener from said barrel.

15. A strap attachment device, comprising:
a base bracket formed with a slide portion, said base bracket attachable to a fastening tool; and
a slide positioned over said slide portion and formed with a U-clip sized to receive a duct strap and retain said duct strap for securing said duct strap to a surface.

16. The strap attachment device of claim 15, further comprising:
said U-clip formed with a right-angled portion;
wherein said duct strap is bendable over said right-angled portion.
